(19) United States
(12) Patent Application Publication
(10) Pub. No.: US 2017/0364195 A1
(43) Pub. Date: Dec. 21, 2017

(54) OUTPUT CONTROL APPARATUS WHICH CONTROLS OUTPUT OF CONTENTS

(71) Applicant: CASIO COMPUTER CO., LTD., Tokyo (JP)

(72) Inventors: Ryo Okumura, Tokyo (JP); Hiroyoshi Ogawa, Tokyo (JP); Shogo Hashimoto, Tokyo (JP); Hiroyuki Kato, Tokyo (JP)

(21) Appl. No.: 15/468,853

(22) Filed: Mar. 24, 2017

(30) Foreign Application Priority Data
Jun. 17, 2016 (JP) 2016-120545

(51) Int. Cl. G06F 3/041

(52) U.S. Cl. CPC G06F 3/0416; G06F 2203/04104; G06F 2203/04105

(57) ABSTRACT

An output control apparatus, including: a touch panel to which a pressing operation is performed by a user; and a processor that is configured to: detect pressing amounts at a plurality of touch points which are simultaneously touched by a user on the touch panel; and perform control of switching an output part in a continuous content on the basis of a relationship between the detected pressing amounts at the respective touch points.

### CROSS-REFERENCE TO RELATED APPLICATION

The entire disclosure of Japanese Patent Application No. 2016-120545 filed on Jun. 17, 2016 including description, claims, drawings and abstract are incorporated herein by reference in its entirety.

### BACKGROUND OF THE INVENTION

### 1. Field of the Invention

The present invention relates to an output control apparatus, an output control method and a storage medium.

### 2. Description of Related Art

Conventionally, there have been known display apparatuses which include operation pieces so as to allow users to perform speed adjustment such as fast-forward, rewind and slow play when reproducing moving images. However, the operation pieces have been provided separately from display units of moving images and thus have obstructed the reduction in size of the display apparatuses.

Thus, a technique of using the direction and speed of slide operation on a touch panel to control the reproduction speed of moving image is disclosed as in Japanese Patent Application Laid Open Publication No. 2004-104594, for example. Also, there is disclosed a technique of displaying a plurality of reproduction speeds so as to be semitransparent on a moving image so that the user can identify the relationship between the position on the touch panel and the reproduction speed as in Japanese Patent Application Laid Open Publication No. 2010-176575, for example.

### SUMMARY OF THE INVENTION

According to one aspect of the present invention, there is provided an output control apparatus, including: a touch panel to which a pressing operation is performed by a user; and a processor that is configured to: detect pressing amounts at a plurality of touch points which are simultaneously touched by a user on the touch panel; and perform control of switching an output part in a continuous content on the basis of a relationship between the detected pressing amounts at the respective touch points.

According to another aspect of the present invention, there is provided an output control method using an output control apparatus that includes a touch panel to which a pressing operation is performed by a user, the method including: detecting pressing amounts at a plurality of touch points which are simultaneously touched by a user on the touch panel; and performing control of switching an output part in a continuous content on the basis of a relationship between the detected pressing amounts at the respective touch points.

According to another aspect of the present invention, there is provided a non-transitory storage medium which stores a program for causing a computer of an output control apparatus to achieve a function, the output control apparatus including a touch panel to which a pressing operation is performed by a user, and the function including: a function of detecting pressing amounts at a plurality of touch points which are simultaneously touched by a user on the touch panel; and a function of performing control of switching an output part in a continuous content on the basis of a relationship between the detected pressing amounts at the respective touch points.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

The present invention will become more fully understood in consideration of the following detailed description with the following drawings, and wherein:

FIG. 1 is a block diagram showing a schematic configuration of an image capturing apparatus in an embodiment to which the present invention is applied;

FIG. 2A is a view for explaining an example of touch manner on a touch panel by a user;

FIG. 2B is a view for explaining an example of touch manner on a touch panel by a user;

FIG. 2C is a view for explaining an example of touch manner on a touch panel by a user;

FIG. 2D is a view for explaining an example of touch manner on a touch panel by a user;

FIG. 3 is a flowchart showing an example of operation of reproduction processing by the image capturing apparatus in FIG. 1;

FIG. 4A is a view schematically showing an example of a combination table of pressing amounts at two touch points;

FIG. 4B is a view schematically showing an example of a combination table of pressing amounts at two touch points;

FIG. 5A is a view for explaining an example of touch manner on a touch panel by a user;

FIG. 5B is a view for explaining an example of touch manner on a touch panel by a user; and

FIG. 5C is a view for explaining an example of touch manner on a touch panel by a user.

### DETAILED DESCRIPTION OF THE PREFERRED EMBODIMENT

Hereinafter, specific embodiments of the present invention will be described by using the drawings. However, the scope of the present invention is not limited to the illustrated examples.

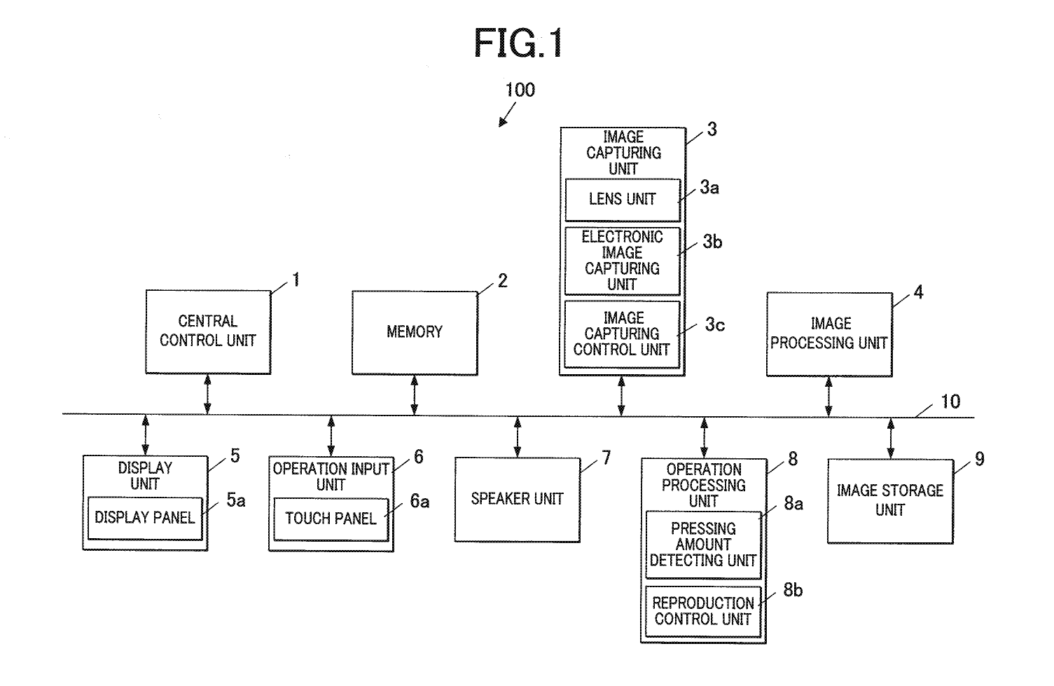

FIG. 1 is a block diagram showing a schematic configuration of an image capturing apparatus 100 in an embodiment to which the present invention is applied.

As shown in FIG. 1, specifically, the image capturing apparatus 100 in the embodiment includes a central control unit 1, a memory 2, an image capturing unit 3, an image processing unit 4, a display unit 5, an operation input unit 6, a speaker unit 7, an operation processing unit 8 and an image storage unit 9.

The central control unit 1, memory 2, image capturing unit 3, image processing unit 4, display unit 5, operation input unit 6, speaker unit 7, operation processing unit 8 and image storage unit 9 are connected to each other via a bus line 10.

The central control unit 1 controls the units of the image capturing apparatus 100. Specifically, the central control unit 1 includes a CPU (Central Processing Unit) and such like not shown in the drawings, and performs various control operations in accordance with various processing programs (not shown in the drawings) for the image capturing apparatus 100.

The memory 2 is configured by including a DRAM (Dynamic Random Access Memory), and temporarily stores data which is processed by the central control unit 1 and the operation processing unit 8, for example.

The image capturing unit 3 captures an image of a predetermined subject at an arbitrary image capturing frame rate to generate a frame image. Specifically, the image capturing unit 3 includes a lens unit 3a, an electronic image capturing unit 3b and an image capturing control unit 3c.

The lens unit 3a is configured by including multiple lenses such as a zoom lens and a focus lens, for example.

The electronic image capturing unit 3b is configured by including an image sensor (image capturing element) such as a CCD (Charge Coupled Device) and a CMOS (Complementary Metal-Oxide Semiconductor), for example. The electronic image capturing unit 3b converts an optical image transmitted various lenses of the lens unit 3a into a two-dimensional image signal.

The image capturing control unit 3c controls the image capturing of the subject by the image capturing unit 3.

That is, the image capturing control unit 3c includes a timing generator, a driver and such like which are not shown in the drawings. The image capturing control unit 3c drives, by the timing generator and the driver, the electronic image capturing unit 3b to scan to convert the optical image transmitted through the lens unit 3a into the two-dimensional image signal every predetermined period, and reads out the frame image from the image capturing area of the electronic image capturing unit 3b for each screen and outputs the frame image to the image processing unit 4.

The image capturing control unit 3c performs adjustment control of conditions such as AF (Automatic Focusing), AE (Automatic Exposure) and AWB (Automatic White Balance) for photographing the subject.

In addition to the lens unit 3a, electronic image capturing unit 3b and image capturing control unit 3c, the image capturing unit 3 may include a diaphragm which adjusts the amount of light transmitted the lens unit 3a, a zoom drive unit which shifts the zoom lens into an optical axial direction, a focusing drive unit which shifts the focus lens into the optical axial direction and such like, which are not shown in the drawings.

The image processing unit 4 performs various types of image signal processing to signals which are analog values of the frame images transferred from the electronic image capturing unit 3b. Specifically, the image processing unit 4 appropriately performs gain adjustment, for each color component of RGB, of the signal which is an analog value of the frame image transferred from the electronic image capturing unit 3b, thereafter performs the sample and hold by the sample-and-hold circuit (not shown in the drawing) and converts it into digital data by an A/D converter (not shown in the drawings). Then, the image processing unit 4 performs color processing including pixel interpolation processing and γ correction processing with a color processing circuit (not shown in the drawings), and thereafter generates a luminance signal Y and color difference signals Cb and Cr (YUV data) which are digital values.

The luminance signal Y and the color difference signals Cb and Cr output from the color processing circuit are DMA-transferred via a DMA controller (not shown in the drawings) to the memory 2 which is used as a buffer memory.

The display unit 5 displays an image on a display screen of a display panel 5a.

That is, the display unit 5 displays a predetermined image on the display screen of the display panel 5a on the basis of the image data of the predetermined size which is decoded by the image processing unit 4. As described later, the display unit 5 reproduces, at a predetermined reproduction frame rate (for example, 30 fps), a moving image which was captured at an arbitrary image capturing frame rate under control of the reproduction control unit 8b of the operation processing unit 8.

The display panel 5a is configured by including a liquid crystal display panel and an organic EL (Electro-Luminescence) display panel, for example. However, these are examples and the present invention is not limited to the examples.

The operation input unit 6 is for performing a predetermined operation of the image capturing apparatus 100. Specifically, the operation input unit 6 includes shutter buttons for instructing image capturing of a still image of a subject, starting recording of a moving image and ending the recording, a selection determination button for instructing selection of an image capturing mode, a reproduction mode, a function and such like, a zoom button for instructing adjustment of zoom amount and such like which are not shown in the drawings.

When any of the various buttons is operated by a user, the operation input unit 6 outputs an operation instruction corresponding to the operated button to the central control unit 1. The central control unit 1 controls the units to execute a predetermined operation (for example, reproduction of a moving image) in accordance with the operation instruction which was output and input from the operation input unit 6.

The operation input unit 6 has a touch panel 6a which is integrally provided with the display panel 5a of the display unit 5.

The touch panel 6a detects X-Y coordinate of a touch point which is touched by a user's finger (hand), a touch pen or the like directly or indirectly touching the display screen forming a display region of the display panel 5a by various methods using capacitance, resistance film and such like, for example. The touch panel 6a is a touch panel which is a pressing amount detection type, and generates a pressing detection signal (analog value) corresponding to the pressing amount (load) at the touch point touched by the user.

The touch panel 6a outputs a position signal and a pressing detection signal according to the X-Y coordinate of the touch point to the operation processing unit 8.

The speaker unit 7 performs D/A conversion to audio data of a moving image with sound to be reproduced by a data conversion unit (not shown in the drawings) and outputs sound under control of the CPU of the central control unit 1. The speaker unit 7 may output an operation sound or alarm sound according to a predetermined operation to the operation input unit 6 by the user.

The operation processing unit 8 includes a pressing amount detecting unit 8a and a reproduction control unit 8b.

Each of the units in the operation processing unit 8 is configured by including a predetermined logic circuit, for example. However, this configuration is an example, and the present invention is not limited to the example.

The pressing amount detecting unit 8a detects a pressing amount at a touch point which is touched by the user on the touch panel 6a.

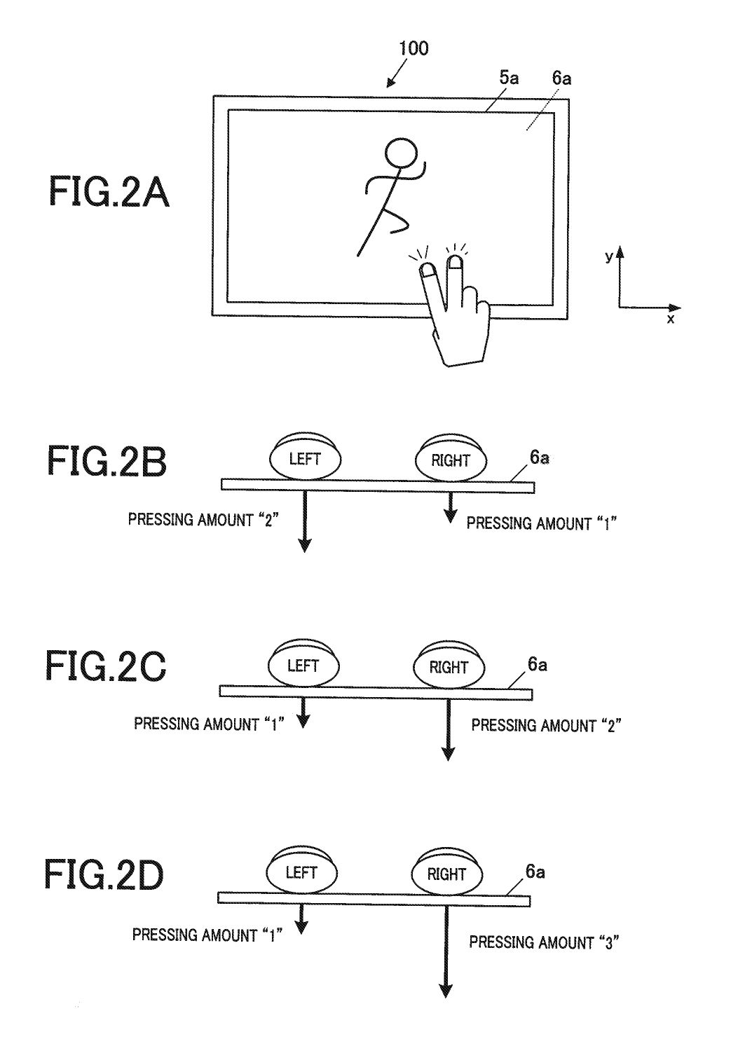

That is, the pressing amount detecting unit (detecting unit) 8a detects respective pressing amounts at a plurality of touch points which are simultaneously touched by the user on the touch panel 6a. For example, as shown in FIG. 2A, different positions on the touch panel 6a are touched by two fingers (for example, index finger and middle finger) of the user, and at this time, the pressing amount detecting unit 8a detects the pressing amounts at the respective touch points on the basis of position signals and pressing detection signals according to X-Y coordinates of the touch points which are output and input from the touch panel 6a. That is, in a case where there are two (a plurality of) touch areas which are simultaneously touched by a user on the touch panel 6a, the pressing amount detecting unit 8a calculates a representative value (for example, average value or maximum value of analog value) of at least one pressing detection signal corresponding to each of the touch areas, and associates the touch areas with the respective touch points to set the calculated representative values as the pressing detection signals at the respective touch points.

Here, the simultaneous touch by a user on the touch panel 6a means that there is at least a period during which two fingers of the user touch the touch panel 6a simultaneously. For example, there may be a time difference in the timing to start touching on the touch panel 6a with user's two fingers or in the timing to release the touch.

Specifically, the pressing amount detecting unit 8a determines a signal level of a pressing detection signal (analog value) by using a plurality of thresholds for each of the touch points associated with the respective two touch areas. The pressing amount detecting unit 8a converts the pressing detection signal into one of a plurality of levels (for example, three levels) of digital values (for example, pressing amounts “1” to “3”) according to the determination result. The larger number among the pressing amounts “1” to “3” expresses that the pressing amount (load of pressing) is larger.

The pressing amount detecting unit 8a outputs the converted pressing amounts at the two touch points to the reproduction control unit 8b.

While the touch panel 6a is touched by the user, the pressing amount detecting unit 8a sequentially detects the pressing amounts at the plurality of touch points. That is, the touch panel 6a sequentially outputs the pressing amount detection signals at the respective touch points over a period during which the touch panel 6a is touched by the user. The pressing amount detecting unit 8a sequentially detects the pressing amounts at the respective touch points on the basis of the pressing detection signals at the respective touch points which are sequentially output and input from the touch panel 6a.

The reproduction control unit 8b controls reproduction of a moving image displayed on the display unit 5.

That is, the reproduction control unit 8b includes, for example, a VRAM (Video Random Access Memory), a VRAM controller, a digital video encoder and such like (none of them shown in the drawings). The digital video encoder reads out, at a predetermined reproduction frame rate (for example, 30 fps), the luminance signal Y and the color difference signals Cb and Cr which were decoded by the image processing unit 4 and stored in the VRAM from the VRAM via the VRAM controller, generates video signals on the basis of these data and outputs the signals to the display panel 5a of the display unit 5.

The reproduction control unit (output control unit) 8b controls the output of moving image (contents) on the basis of a relationship between the pressing amounts at the plurality of (two) touch points detected by the pressing amount detecting unit 8a. Specifically, the reproduction control unit 8b controls the reproduction direction (feed direction) and the reproduction speed (feed speed) of the reproduced moving image on the basis of a difference between pressing amounts at the two touch points detected by the pressing amount detecting unit 8a. The control of reproduction speed of a moving image is performed by changing at least one of the reproduction frame rate and thinning rate, for example. The setting of the reproduction frame rate and thinning rate is a known technique, and thus, detailed description is omitted.

The reproduction control unit 8b further controls the output of moving image on the basis of a relationship between the two touch points which are simultaneously touched by the user on the touch panel 6a. Specifically, the reproduction control unit 8b controls the reproduction speed of reproduced moving image on the basis of a relationship between the two touch points detected by the pressing amount detecting unit 8a.

Specifically, on the basis of position signals of the two touch points having the pressing amounts detected by the pressing amount detecting unit 8a, the reproduction control unit 8b specifies whether the positional relationship therebetween is a relationship of being located left and right (x axis direction) (see FIG. 2A) or a relationship of being located up and down (y axis direction). Here, the positional relationship is determined according to whether the angle between the line connecting the two touch points and a predetermined axis (for example, x axis or y axis) is within a predetermined angle range, for example.

The reproduction control unit 8b calculates the difference in pressing amount by setting any one of the two touch points to be a reference. For example, in a case where the two touch points are in a relationship of being located left and right, the pressing amount of left touch point is subtracted from the pressing amount of right touch point. In a case where the two touch points are in a relationship of being located up and down, the pressing amount of lower touch point is subtracted from the pressing amount of the upper touch point.

The reproduction control unit 8b sets the reproduction direction to a forward direction when the sign of the calculated difference in pressing amount is “positive”, and the reproduction control unit 8b sets the reproduction direction to a backward direction when the sign of the calculated difference in pressing amount is “negative”. For example, as shown in FIG. 2B, when the pressing amount of left touch point is larger than the pressing mount of right touch point, the sign of the calculated difference in pressing amount is “negative”, and the reproduction direction is set to be the backward direction. On the other hand, as shown in FIG. 2C, when the pressing amount of right touch points is larger than the pressing amount of left touch point, the sign of calculated difference in pressing amount is “positive”, and the reproduction direction is set to be the forward direction.

In a case where the two touch points are in a relationship of being located left and right, the reproduction control unit 8b sets the reproduction speed to 1-time speed when the quantity (absolute value) of the calculated difference in pressing amount is “1” (see FIGS. 2B and 2C), and the reproduction control unit 8b sets the reproduction speed to 2-times speed when the quantity of the calculated difference in pressing amount is “2” (see FIG. 2D). In a case where the two touch points are in a positional relationship of being located up and down, the reproduction control unit 8b sets the reproduction speed to 1-time speed when the quantity of the calculated difference in pressing amount is “1”, and the reproduction control unit 8b sets the reproduction speed to 0.5-times speed when the quantity of the calculated difference in pressing amount is “2”.

FIGS. 2B to 2D schematically show the quantity of pressing amounts by the lengths of arrows.

That is, in a case where the two touch points are in a relationship of being located left and right, the reproduction control unit 8b can control the reproduction of moving image so as to fast forward or fast backward with respect to the normal reproduction speed. On the other hand, in a case where the two touch points are in a relationship of being located up and down, the reproduction control unit 8b can control the reproduction of moving image so as to slow forward or slow backward with respect to the normal reproduction speed.

The reproduction control unit 8b sequentially controls the reproduction of moving image according to the change in relationship between the pressing amounts at the two touch points which are sequentially detected by the pressing amount detecting unit 8a. That is, the reproduction control unit 8b sequentially controls the reproduction direction of moving image and sequentially controls the reproduction speed of reproduced moving image according to the change in relationship between the pressing amounts of the two touch points over a period during which the touch panel 6a is simultaneously touched by two fingers of the user.

When the touch on the touch panel 6a by user's two fingers is released, the reproduction control unit 8b controls the reproduction of moving image with the reproduction direction and the reproduction speed corresponding to the relationship between the pressing amounts at the two touch points at the timing when the touch was released.

The release of touch on the touch panel 6a by user's two fingers includes the operation of releasing touch by the two fingers nearly simultaneously, the operation of releasing touch with a time difference between the two fingers, and the operation of releasing touch by only one of the fingers.

The image storage unit 9 is configured by including a non-volatile memory (flash memory), for example, and stores image data for storing a still image and a moving image which were encoded in a predetermined compression format by an encoding unit (not shown in the drawings) of the image processing unit 4.

Examples of file formats for moving images include MOV format with pixels of 1280×720 pixels and image capturing frame rate of 30 fps, and a format conforming to H.264/AVC. In a case of a moving image with sound, the sound is encoded in IMA-ADPCM format (stereophonic sound), for example.

The image data stored in the image storage unit 9 may be data of an image which was captured by the image capturing unit 3 of the image capturing apparatus 100 and stored, or may be data of an image which was captured by an external image capturing apparatus (not shown in the drawings) and thereafter transferred to the image capturing apparatus 100 to be stored in the image storage unit 9.

The image storage unit 9 may be capable of attaching and detaching a storage medium (not shown in the drawings) and may control the data reading from the loaded storage medium and the data writing onto the storage medium.

### <Reproduction Processing>

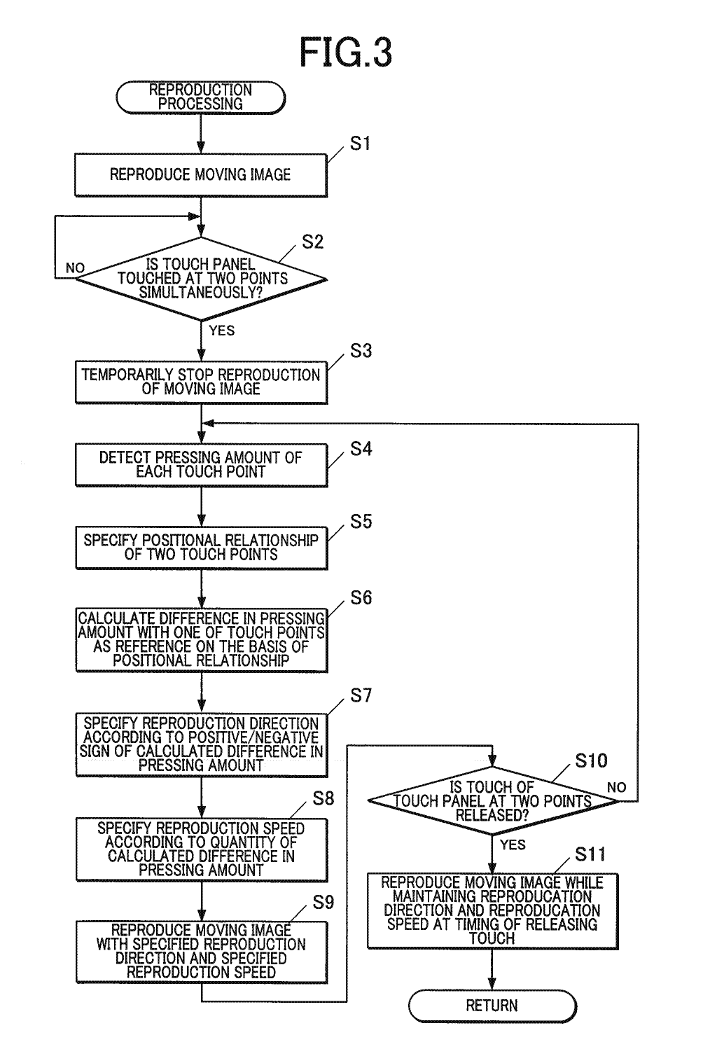

Next, the reproduction processing by the image capturing apparatus 100 will be described with reference to FIG. 3.

FIG. 3 is a flowchart showing an example of operation according to the reproduction processing.

As shown in FIG. 3, first, when a moving image to be a reproduction target is specified from among the moving images stored in the image storage unit 9 on the basis of user's predetermined operation to the operation input unit 6, the image processing unit 4 reads out the specified moving image from the image storage unit 9 and decodes the moving image according to the encoding format. The reproduction control unit 8b outputs a plurality of frame images forming the moving image of reproduction target which was decoded by the image processing unit 4 to the display unit 5, and reproduces the moving image at a normal reproduction speed on the display panel 5a (step S1).

The frame image specified by the reproduction control unit 8b can be displayed on the display panel 5a immediately by the image processing unit 4 performing, in advance, decoding processing of frame images for the amount of a predetermined period among the plurality of frame images forming the moving image of reproduction target, and storing the decoded data in a predetermined storage unit (for example, memory 2).

Next, the pressing amount detecting unit 8a determines whether two positions on the touch panel 6a are simultaneously touched by the user (step S2). Specifically, the pressing amount detecting unit 8a performs the above determination on the basis of inputs of position signals and pressing detection signals for the X-Y coordinates of touch points which are output from the touch panel 6a by the user touching the touch panel 6a.

Here, if it is not determined that the two position on the touch panel 6a are simultaneously touched (step S2; NO), the pressing amount detecting unit 8a repeatedly executes, at a predetermined time interval, the processing of determining whether the two positions on the touch panel 6a are simultaneously touched by the user.

In step S2, if it is determined that the two positions on the touch panel 6a are simultaneously touched (step S2; YES), the reproduction control unit 8b temporarily stops the reproduction of moving image while displaying the frame image which was displayed on the display panel 5a when the two positions on the touch panel 6a were simultaneously touched by the user (step S3). The pressing amount detecting unit 8a detects pressing amounts (such as pressing amounts “1” to “3”) at the two touch points on the basis of the position signals and the pressing detection signals for the X-Y coordinates of touch points which were output and input from the touch panel 6a, and the pressing amount detecting unit 8a outputs the detected pressing amounts to the reproduction control unit 8b (step S4).

The reproduction control unit 8b specifies the positional relationship between the two touch points (for example, relationship of being located left and right) on the basis of the position signals of the two touch points having the pressing amounts detected by the pressing amount detecting unit 8a (step S5). The reproduction control unit 8b calculates the difference in pressing mount by setting one of the touch points (for example, the right touch point) to be a reference on the basis of the specified positional relationship between the two touch points (step S6). The reproduction control unit 8b then specifies the reproduction direction (for example, forward direction when the sign is “positive”) according to the positive/negative sign of the calculated difference in pressing amount (step S7). The reproduction control unit 8b specifies the reproduction speed (for example, 2-times speed when the quantity of difference in pressing amount is “2”) according to the quantity (absolute value) of calculated difference in pressing amount (step S8).

The reproduction control unit 8b reproduces the moving image by controlling the reproduction frame rate and the thinning rate so as to set the reproduction direction and the reproduction speed to the specified reproduction direction and the specified reproduction speed (step S9).

Thereafter, the pressing amount detecting unit 8a determines whether the touch at two touch points on the touch panel 6a by the user is released (step S10). The determination is performed on the basis of the inputs of position signals and pressing detection signals for the X-Y coordinates of the touch points output from the touch panel 6a, similarly to the determination in step S2.

If it is not determined that the touch at two touch points on the touch panel 6a is released (step S10; NO), the pressing amount detecting unit 8a returns the processing to step S4, and similarly to the above-described processing, detects the pressing amounts (such as pressing amounts “1” to “3”) of the two touch points and outputs the detected pressing amounts to the reproduction control unit 8b (step S4). Thereafter, similarly to the above-mentioned processing, the reproduction control unit 8b performs the processing of steps S5 to S9 to sequentially control the reproduction direction and reproduction speed of the moving image according to the change in relationship between the pressing amounts of two touch points which are sequentially detected by the pressing amount detecting unit 8a.

On the other hand, in step S10, if it is determined that the touch at the two touch points on the touch panel 6a is released (step S10; YES), the reproduction control unit 8b reproduces the moving image while maintaining the reproduction direction and the reproduction speed corresponding to the relationship between the pressing amounts of two touch points at the timing when the touch was released (step S11).

As described above, according to the image capturing apparatus 100 in the embodiment, it is possible to control reproduction of a moving image (output of contents) on the basis of the relationship between the pressing amounts at a plurality of touch points which are simultaneously touched by a user on the touch panel 6a, for example, at two touch points corresponding to two touch areas which are touched by user's two fingers. Thus, for example, in a case of changing the reproduction direction or reproduction speed of the moving image, it is possible to control the reproduction of moving image without moving the touch points touched by the user on the touch panel 6a.

Furthermore, since the reproduction of moving image is controlled on the basis of the difference between pressing amounts at a plurality of touch points on the touch panel 6a, in a case of changing the reproduction direction or reproduction speed of the moving image, for example, it is possible to easily change the reproduction direction or reproduction speed of the moving image by the user only adjusting the load of pressing at the plurality of touch points on the touch panel 6a, without moving the touch points touched by the user on the touch panel 6a. Especially, since the touch points touched by the user on the touch panel 6a need not be moved, the display of the moving image reproduced on the display panel 5a is not disturbed, and thus, the user can change the reproduction direction and reproduction speed with intuitive operation while watching the moving image.

Furthermore, while the touch panel 6a is touched by the user, it is possible to sequentially detect the pressing amounts at a plurality of touch points on the touch panel 6a and sequentially change the reproduction direction and reproduction speed of the moving image according to the change in relationship between the sequentially detected pressing amounts at the plurality of touch points.

Since the reproduction of moving image is controlled on the basis of the relationship between the plurality of touch points which are simultaneously touched by the user on the touch panel 6a, it is possible to perform more various reproduction controls of moving image by assigning a different control content (details of control) for each positional relationship between the plurality of touch points on the touch panel 6a.

The present invention is not limited to the above embodiment, and various modifications and design changes may be performed within the scope of the present invention.

Hereinafter, modification examples of image capturing apparatus 100 of the embodiment will be described.

Here, the image capturing apparatuses in the modification examples have nearly same configurations and functions as those of the image capturing apparatus 100 in the embodiment except for the respects described below, and thus, the specific explanation thereof is omitted.

### Modification Example 1

Hereinafter, a modification example 1 of the image capturing apparatus 100 will be described.

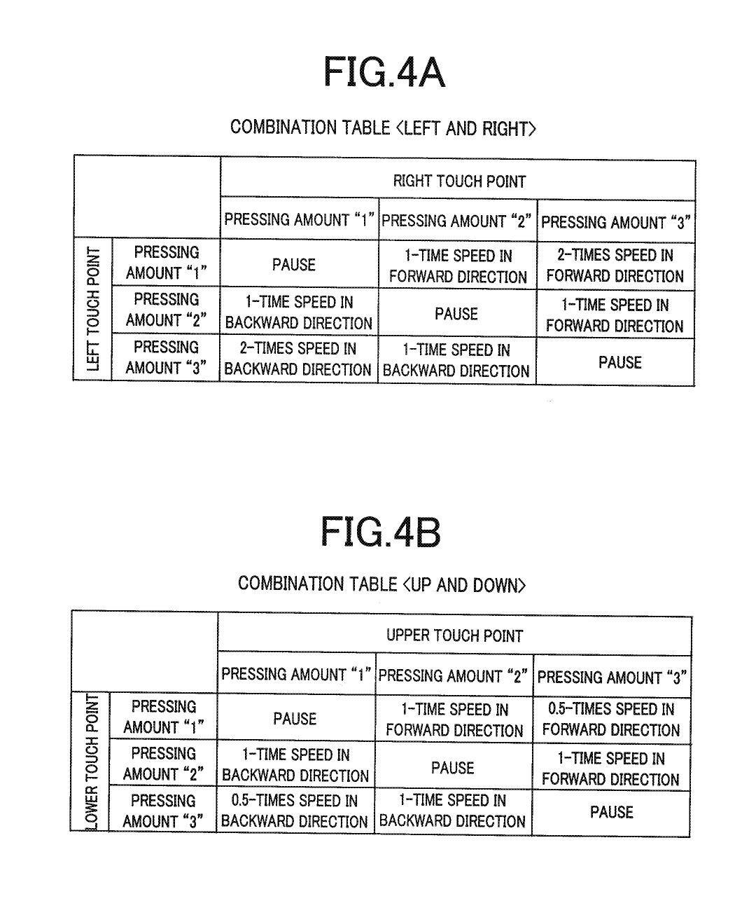

In the modification example 1, the reproduction control unit 8b controls the output of moving image (content) on the basis of combination of pressing amounts at a plurality of (two) touch points. Specifically, in reproduction processing, the reproduction control unit 8b controls the reproduction direction and reproduction speed by using combination tables (see FIGS. 4A and 4B) of pressing amounts at the two touch points which are simultaneously touched by a user on the touch panel 6a.

FIG. 4a schematically shows an example of a combination table <left and right> of pressing amounts used in a case where the two touch points are in a relationship of being located left and right.

The combination table <left and right> is used when controlling reproduction of a moving image so as to fast forward or fast backward the reproduction with respect to the normal reproduction speed. Specifically, the pressing amounts “1” to “3” of the right touch point, the pressing amounts “1” to “3” of the left touch point and control contents (such as reproduction direction and reproduction speed) are associated with each other.

For example, in a case where the pressing amount of right touch point is “1” and the pressing amount of left touch point is “1”, the control content of moving image is “pause” which means temporarily stopping the reproduction of moving image. In a case where the pressing amount of right touch point is “1” and the pressing amount of left touch point is “2”, the control content of moving image is “1-time speed in backward direction” which means setting the reproduction direction of moving image to backward direction and reproduction speed to 1-time speed. In a case where the pressing amount of right touch point is “1” and the pressing amount of left touch point is “3”, the control content of moving image is “2-times speed in backward direction” which means setting the reproduction direction of moving image to backward direction and the reproduction speed to 2-times speed.

In a case where the pressing amount of right touch point is “2” and the pressing amount of left touch point is “1”, the control content of moving image is “1-time speed in forward direction” which means setting the reproduction direction of moving image to forward direction and reproduction speed to the 1-time speed. In a case where the pressing amount of right touch point is “2” and the pressing amount of left touch point is “2”, the control content of moving image is “pause” which means temporarily stopping the reproduction of moving image. In a case where the pressing amount of right touch point is “2” and the pressing amount of left touch point is “3”, the control content of moving image is “1-time speed in backward direction” which means setting the reproduction direction of moving image to backward direction and the reproduction speed to 1-time speed.

In a case where the pressing amount of right touch point is “3” and the pressing amount of left touch point is “1”, the control content of moving image is “2-times speed in forward direction” which means setting the reproduction direction of moving image to forward direction and reproduction speed to the 2-times speed. In a case where the pressing amount of right touch point is “3” and the pressing amount of left touch point is “2”, the control content of moving image is “1-time speed in forward direction” which means setting the reproduction direction of moving image to forward direction and reproduction speed to the 1-time speed. In a case where the pressing amount of right touch point is “3” and the pressing amount of left touch point is “3”, the control content of moving image is “pause” which means temporarily stopping the reproduction of moving image.

FIG. 4B schematically shows an example of a combination table <up and down> of pressing amounts used in a case where the two touch points are in a positional relationship of being located up and down.

The combination table <up and down> is used when controlling the reproduction of moving image so as to slow forward or slow backward the moving image with respect to the normal reproduction speed. Specifically, the pressing amounts “1” to “3” of the upper touch point, the pressing amounts “1” to “3” of the lower touch point and control contents (such as reproduction direction and reproduction speed) of the moving image are associated with each other.

For example, in a case where the pressing amount of upper touch point is “1” and the pressing amount of lower touch point is “1”, the control content of moving image is “pause” which means temporarily stopping the reproduction of moving image. In a case where the pressing amount of upper touch point is “1” and the pressing amount of lower touch point is “2”, the control content of moving image is “1-time speed in backward direction” which means setting the reproduction direction of moving image to backward direction and reproduction speed to 1-time speed. In a case where the pressing amount of upper touch point is “1” and the pressing amount of lower touch point is “3”, the control content of moving image is “0.5-times speed in backward direction” which means setting the reproduction direction of moving image to backward direction and the reproduction speed to 0.5-times speed.

In a case where the pressing amount of upper touch point is “2” and the pressing amount of lower touch point is “1”, the control content of moving image is “1-time speed in forward direction” which means setting the reproduction direction of moving image to forward direction and reproduction speed to the 1-time speed. In a case where the pressing amount of upper touch point is “2” and the pressing amount of lower touch point is “2”, the control content of moving image is “pause” which means temporarily stopping the reproduction of moving image. In a case where the pressing amount of upper touch point is “2” and the pressing amount of lower touch point is “3”, the control content of moving image is “1-time speed in backward direction” which means setting the reproduction direction of moving image to backward direction and the reproduction speed to 1-time speed.

In a case where the pressing amount of upper touch point is “3” and the pressing amount of lower touch point is “1”, the control content of moving image is “0.5-times speed in forward direction” which means setting the reproduction direction of moving image to forward direction and reproduction speed to the 0.5-times speed. In a case where the pressing amount of upper touch point is “3” and the pressing amount of lower touch point is “2”, the control content of moving image is “1-time speed in forward direction” which means setting the reproduction direction of moving image to forward direction and reproduction speed to the 1-time speed. In a case where the pressing amount of upper touch point is “3” and the pressing amount of lower touch point is “3”, the control content of moving image is “pause” which means temporarily stopping the reproduction of moving image.

The above combination table <left and right> and combination table <up and down> are examples, and the present invention is not limited to them. Modifications can be appropriately made arbitrarily.

In the reproduction processing (see FIG. 3), instead of the processing in steps S6 to S8, the reproduction control unit 8b specifies a combination table to be used (for example, combination table <left and right>) on the basis of the positional relationship between the two touch points specified in step S5. Then, the reproduction control unit 8b uses the specified combination table to specify the reproduction direction and the reproduction speed corresponding to the relationship between the pressing amounts at the two touch points, and thereafter controls the reproduction frame rate and the thinning rate so as to set the specified reproduction direction and the specified reproduction speed and reproduces the moving image (step S9).

Accordingly, according to the modification example 1, it is possible to control reproduction of moving image on the basis of combination of pressing amounts at the plurality of touch points on the touch panel 6a, and similarly to the above embodiment, for example, in a case of changing the reproduction direction and reproduction speed of a moving image, it is possible to easily change the reproduction direction and reproduction speed of the moving image by the user only adjusting the load of pressing at the plurality of touch points on the touch panel 6a, without moving the touch points touched by the user on the touch panel 6a.

In the reproduction processing of the embodiment and the modification example 1, the control of reproduction of a moving image by the reproduction control unit 8b is performed while the moving image is reproduced at a normal reproduction speed. For example, if it is determined that the two positions on the touch panel 6a are simultaneously touched (step S2; YES), the reproduction of moving image is temporarily stopped (step S3). However, this is an example, and the present invention is not limited to this. For example, in a case where the two positions on the touch panel 6a are simultaneously touched while the reproduction of moving image is stopped and there is no difference between pressing amounts of the two touch points, the reproduction control unit 8b may control to reproduce the moving image at the normal reproduction speed.

### Modification Example 2

Hereinafter, a modification example 2 of the image capturing apparatus 100 will be described.

In the modification example 2, the reproduction control unit 8b controls output of a moving image (content) on the basis of a quantity relationship between pressing amounts at the plurality of (two) touch points. Specifically, in the reproduction processing, the reproduction control unit 8b specifies the quantity relationship between the pressing detection signals at the two touch points which are simultaneously touched by the user on the touch panel 6a, and controls the reproduction direction and the reproduction speed according to the specified quantity relationship.

For example, when the position signals and pressing detection signals for the X-Y coordinates of respective touch points, which were output from the touch panel 6a, are input, the pressing amount detecting unit 8a obtains the input pressing detection signals as pressing amounts. Then, the pressing amount detecting unit 8a outputs the position signals and pressing detection signals for the X-Y coordinates of the respective touch points to the reproduction control unit 8b.

The reproduction control unit 8b specifies the positional relationship (for example, positional relationship of being located left and right) of the two touch points on the basis of the position signals of the two touch points. Then, the reproduction control unit 8b specifies the quantity relationship between the pressing detection signals of the two touch points, and controls the reproduction direction and the reproduction speed of the moving image according to the specified quantity relationship. For example, in a case where the pressing detection signal of right touch point is larger than the pressing detection signal of left touch point by a predetermined threshold or more, the reproduction control unit 8b sets the reproduction direction to forward direction and the reproduction speed to 2-times speed. In a case where the pressing detection signal of left touch point is larger than the pressing detection signal of right touch point by a predetermined threshold or more, the reproduction control unit 8b sets the reproduction direction to backward direction and the reproduction speed to 2-times speed. In a case where the difference between the pressing detection signals of left and right touch points is smaller than a predetermined threshold, the reproduction control unit 8b sets the reproduction direction to forward direction and the reproduction speed to 1-time speed.

Though the detailed description is omitted, in a case where the two touch points are in a positional relationship of being located up and down, similarly to the above embodiment and the modification example 1, the reproduction direction and reproduction speed of the moving image is controlled so as to slow forward or slow backward the moving image.

In the reproduction processing (see FIG. 3), instead of the processing in steps S6 to S8, the reproduction control unit 8b specifies the reproduction direction and the reproduction speed corresponding to the quantity relationship between pressing detection signals at the two touch points, and thereafter controls the reproduction frame rate and the thinning rate to set the specified reproduction direction and the specified reproduction speed and reproduces the moving image (step S9).

Accordingly, according to the modification example 2, it is possible to control the reproduction of moving image on the basis of the quantity relationship between pressing amounts at the plurality of touch points on the touch panel 6a. Similarly to the above embodiment, in a case of changing the reproduction direction and reproduction speed of moving image, for example, it is possible to easily change the reproduction direction and reproduction speed of the moving image by the user only adjusting the load of pressing at the plurality of touch points on the touch panel 6a, without moving the touch points touched by the user on the touch panel 6a.

### Modification Example 3

Hereinafter, a modification example 3 of the image capturing apparatus 100 will be described.

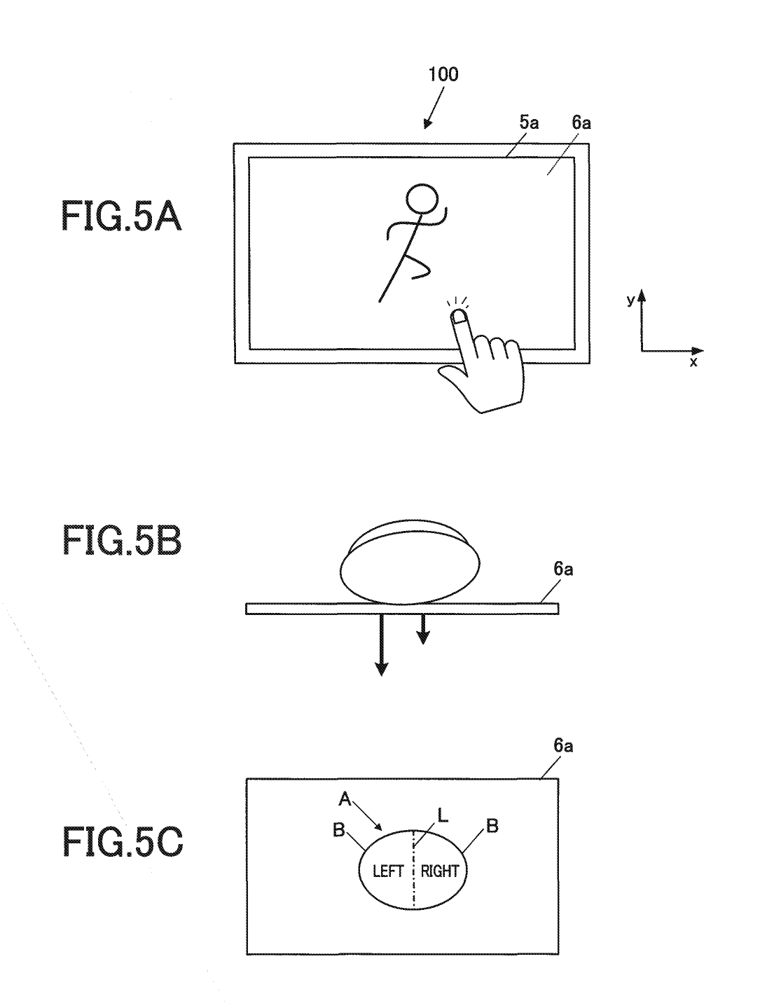

The modification example 3 is applied, for example, to a case where the touch panel 6a is touched by user's single finger (for example, index finger) as shown in FIG. 5A.

In this case of modification example 3, the pressing amount detecting unit 8a detects, as pressing amounts at a plurality of touch points, the distribution of the plurality of pressing amounts in a single touch area A which is touched by the user on the touch panel 6a. Specifically, when a plurality of position signals and pressing detection signals corresponding to the single touch area A are output from the touch panel 6a and input to the pressing amount detecting unit 8a, the pressing amount detecting unit 8a divides the single touch area A into a plurality of partial areas B (for example, left and right or upper and lower partial areas) with a reference line L extending in a predetermined direction (for example, y axis direction or x axis direction) on the basis of the input plurality of position signals. Then, the pressing amount detecting unit 8a calculates a representative value (for example, average value or maximum value which is analog value) of at least one pressing detection signal corresponding to each of the partial areas B (see FIGS. 5B and 5C).

The reproduction control unit 8b controls reproduction of moving image on the basis of distribution of a plurality of pressing amounts in the single touch area A detected by the pressing amount detecting unit 8a. Specifically, the reproduction control unit 8b specifies the quantity relationship between the pressing detection signals (representative values) between the plurality of partial areas (for example, left and right partial areas), and controls the reproduction direction and the reproduction speed of moving image according to the specified quantity relationship. For example, in a case where the pressing detection signal of right partial area B is larger than the pressing detection signal of left partial area B by a predetermined threshold or more, the reproduction control unit 8b sets the reproduction direction to forward direction and reproduction speed to 2-times speed. In a case where the pressing detection signal of left partial area B is larger than the pressing detection signal of right partial area B by the predetermined threshold or more, the reproduction control unit 8b sets the reproduction direction to backward direction and reproduction speed to 2-times speed. In a case where the difference between pressing detection signals of right and left partial areas B is smaller than the predetermine threshold, the reproduction control unit 8b sets the reproduction direction to forward direction and reproduction speed to 1-time speed.

Though the detailed description is omitted, in a case where the two partial areas B and B are in a positional relationship of being located up and down, the production direction and production speed of moving image are controlled so as to slow forward or slow backward the moving image, similarly to the above embodiment and modification examples 1 and 2.

In the reproduction processing (see FIG. 3), instead of the processing in steps S6 to S8, the reproduction control unit 8b specifies the reproduction direction and the reproduction speed corresponding to the quantity relationship between the pressing detection signals (representative values) at the two partial areas, thereafter controls the reproduction frame rate and the thinning rate to set the specified reproduction direction and the specified reproduction speed and reproduces the moving image (step S9).

When the touch on the touch panel 6a by user's single finger is released (step S10; YES), reproduction control unit 8b performs control to reproduce the moving image while maintaining the reproduction direction and the reproduction speed corresponding to the quantity relationship between pressing detection signals (representative values) of the two partial areas B and B at the timing when the touch was released, similarly to the above embodiment and modification examples 1 and 2.

Similarly to the above embodiment and modification example 1, the pressing amount detection unit 8a may convert the calculated pressing detection signals (representative values) of the respective partial areas B into the pressing amounts “1” to “3” which are three levels of digital values, and the reproduction control unit 8b may control the reproduction direction and reproduction speed of moving image according to the pressing amounts “1” to “3” of the two partial areas B and B.

Accordingly, according to the modification example 3, even in a case where the touch panel 6a is touched by user's single finger, the reproduction of moving image can be controlled on the basis of the distribution of a plurality of pressing amounts in a single touch area A touched by the user on the touch panel 6a. Similarly to the above embodiment, in a case of changing the reproduction direction and reproduction speed of moving image, for example, the reproduction of moving image can be controlled without moving the touch point touched by the user on the touch panel 6a.

In the above embodiment and modification examples 1 and 2, the relationship of being located left and right or up and down is illustrated as the positional relationship between the two touch points, and in the modification example 3, the relationship of being located left and right or up and down is illustrated as the positional relationship between two partial areas B and B. However, the relationships are examples, and the present invention is not limited to them. For example, the relationship may be appropriately and arbitrarily changed to “left and up”, “left and down”, “right and up”, “right and down”, “upper left and lower right”, “upper right and lower left” and such like. In these cases, the calculation of difference in pressing amounts “1” to “3”, combination and difference in pressing detection signals are also performed by the positional relationship similar to the above.

The control contents of reproduction direction and reproduction speed of moving image corresponding to the difference and combination of pressing amounts and the difference in pressing detection signals which are illustrated in the above embodiment and modification examples are examples, and the present invention is not limited to the examples. Modifications can be appropriately made arbitrarily.

Furthermore, in the above embodiment and modification examples 1 and 2, the two touch points are illustrated as a plurality of touch points which are simultaneously touched by a user on the touch panel 6a. However, the two touch points are examples, and the present invention is not limited to the examples. There may be three touch points or more.

For example, in a case where there are three touch points of left, middle and right, when the pressing amount of middle touch point is “1”, the reproduction speed of moving image may be set to high speed with respect to the normal reproduction speed, and similarly to the above embodiment and modification examples, the reproduction speed and reproduction direction of moving image may be controlled according to the relationship between pressing amounts of left and right touch points. On the other hand, when the pressing amount of middle touch point is “2” or more, the reproduction speed of moving image may be set to a low speed with respect to the normal reproduction speed, and the processing contents corresponding to the positional relationship of being located up and down illustrated in the above embodiment and modification examples may be used to control the reproduction speed and reproduction direction of moving image according to the relationship between pressing amounts of left and right touch points.

In the above embodiment and modification examples, the control of reproduction speed and reproduction direction of moving image is illustrated as the control contents of reproduction of moving image. However, the control is an example, and the present invention is not limited to this example. For example, on the basis of relationship between pressing amounts of a plurality of touch points, zoom-in and zoom-out operations may be switched or the zoom-in and zoom-out magnification may be changed.

The configuration of the image capturing apparatus 100 illustrated in the above embodiment is an example, and the present invention is not limited to this. Though the image capturing apparatus 100 is illustrated as an output control apparatus, the image capturing apparatus 100 is an example, and the present invention is not limited to this. Whether to include the image capturing function may be appropriately and arbitrarily changed.

Though the control when reproducing the moving image is illustrated as output control of contents, the control is an example. The present invention is not limited to this example, and modification can be made appropriately and arbitrarily. For example, when a plurality of still images is displayed by a slide show, the changing speed, changing direction and such like may be controlled. When a web page or application screen is displayed, the scroll speed, scroll direction or the like may be controlled. When music is played, the switching speed, switching direction, sound volume and such like of the music may be controlled. In these cases, the output of contents can be controlled without moving the touch points touched by the user on the touch panel 6a.

In addition, in the above embodiment, the functions as a detection unit and an output control unit are achieved by driving the pressing amount detecting unit 8a and the reproduction control unit 8b under the control of central control unit 1. However, the present invention is not limited to this, and the functions as a detection unit and an output control unit may be achieved by the CPU of the central control unit 1 executing a predetermined program or the like.

That is, programs including detection processing routine and output control processing routine are stored in a program memory (not shown in the drawings). Then, the CPU of central control unit 1 may be caused by the detection processing routine to achieve the function of detecting the pressing amounts of the plurality of respective touch points which are simultaneously touched by a user on the touch panel 6a. Also, the CPU of the central control unit 1 may be caused by the output control processing routine to achieve the function of controlling output of contents (moving image) on the basis of the relationship between detected pressing amounts at the plurality of touch points.

Furthermore, as a computer readable medium storing a program for executing the above processing, in addition to a ROM, a hard disk and such like, a non-volatile memory such as a flash memory and a portable storage medium such as a CD-ROM can be applied. As a medium providing data of program via a predetermined communication line, a carrier wave is also applied.

Though several embodiments of the present invention have been described, the scope of the present invention is not limited to the above-mentioned embodiments, and includes the scope of inventions, which is described in the scope of claims, and the scope equivalent thereof.

What is claimed is:

1. An output control apparatus, comprising:
a touch panel to which a pressing operation is performed by a user; and
a processor that is configured to:
detect pressing amounts at a plurality of touch points which are simultaneously touched by a user on the touch panel; and
perform control of switching an output part in a continuous content on the basis of a relationship between the detected pressing amounts at the respective touch points.

2. The output control apparatus according to claim 1, wherein the processor performs the control of switching the output part in the continuous content on the basis of a quantity relationship between the detected pressing amounts at the respective touch points.

3. The output control apparatus according to claim 1, wherein the processor performs the control of switching the output part in the continuous content on the basis of a difference between the detected pressing amounts at the respective touch points.

4. The output control apparatus according to claim 1, wherein the processor performs the control of switching the output part in the continuous content on the basis of a combination of the detected pressing amounts at the respective touch points.

5. The output control apparatus according to claim 1, wherein the processor performs control of a direction, in which the output part in the continuous content is switched, on the basis of a relationship between the detected pressing amounts at the respective touch points.

6. The output control apparatus according to claim 1, wherein the processor performs control of a speed, at which the output part in the continuous content is switched, on the basis of a relationship between the detected pressing amounts at the respective touch points.

7. The output control apparatus according to claim 1, wherein
the processor sequentially detects the pressing amounts at the respective touch points while the user continues touch on the touch panel, and
the processor sequentially performs the control of switching the output part in the continuous content according to a change in a relationship between the pressing amounts at the respective touch points which are sequentially detected.

8. The output control apparatus according to claim 1, wherein
the processor further detects positions of the respective touch points which are simultaneously touched by the user on the touch panel, and
the processor performs the control of switching the output part in the continuous content on the basis of a relationship between the detected positions of the respective touch points.

9. The output control apparatus according to claim 1, wherein
the processor detects at least one pressing amount corresponding to each of a plurality of touch areas which are simultaneously touched by the user on the touch panel, and
the processor sets a plurality of detected pressing amounts to be the pressing amounts at the respective touch points.

10. The output control apparatus according to claim 1, wherein
the processor divides a single touch area, which is touched by the user on the touch panel, into a plurality of areas on the basis of distribution of pressing amounts in the single touch area, and
the processor detects, as the pressing amounts at the respective touch points, pressing amounts at the respective areas which are obtained by dividing the single touch area.

11. An output control method using an output control apparatus that includes a touch panel to which a pressing operation is performed by a user, the method comprising:
detecting pressing amounts at a plurality of touch points which are simultaneously touched by a user on the touch panel; and
performing control of switching an output part in a continuous content on the basis of a relationship between the detected pressing amounts at the respective touch points.

12. A non-transitory storage medium which stores a program for causing a computer of an output control apparatus to achieve a function, the output control apparatus including a touch panel to which a pressing operation is performed by a user, and the function comprising:
a function of detecting pressing amounts at a plurality of touch points which are simultaneously touched by a user on the touch panel; and
a function of performing control of switching an output part in a continuous content on the basis of a relationship between the detected pressing amounts at the respective touch points.
